(19) United States
(12) Patent Application Publication
(10) Pub. No.: US 2006/0288276 A1
(43) Pub. Date: Dec. 21, 2006

(54) Structured document processing system

(75) Inventors: Junichi Odagiri, Kawasaki (JP); Satoshi Nakashima, Kawasaki (JP); Shigeru Yoshida, Kawasaki (JP); Takuroh Yamaguchi, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/236,608

(22) Filed: Sep. 28, 2005

(30) Foreign Application Priority Data
Jun. 20, 2005 (JP) 2005-179120

(51) Int. Cl. G06F 17/00

(52) U.S. Cl. 715/513

(57) ABSTRACT

When analyzing two XML documents and merging data, record tags are specified in each XML document, and data enclosed with the record tags is stored as a group of text data. Then, by retrieving text from the text data, data needed for a process is detected and used for the process. If the text data can be processed as it is, it is processed as it is. If a more complex process is needed, the text data is converted into objects, and the objects are processed. In this case, the number or capacity of the objects is restricted in such a way not to give too much load to the system.

### BACKGROUND OF THE INVENTION

1. Field of the Invention

The present invention relates to a structured document processing system for processing structured documents, such as a standard generated markup language (SGML) document, an extensible markup language (XML) document, a hypertext markup language (HTML) document and the like.

2. Description of the Related Art

With the remarkable spread of the Internet, more and more data linked among a plurality of systems and services via the Internet has been described as structured documents. This has been caused by the fact that as data linkage has been diversified, it has been necessitated that a data structure can be easily determined or extended. The structure document has not only data but also tags indicating the meaning of data.

FIG. 1 shows the data structure of a structured document.

<Commodity description> is a tag indicating the beginning of data for a commodity description, and </commodity description> is a tag indicating the end of data for a commodity description. In this way, the contents of data whose type is indicated by a tag are enclosed with a start tag and an end tag.

Each system or service knows the meaning of data, based on this tag and automatically processes the data. This structured document is a simple text document. Therefore, when you want to add some data, it is enough if the data is enclosed with tags. Currently, of structured documents, particularly an XML document is used.

As to XML data, although its data structure can be easily determined and extended, the amount of data simply increases by the tags. Furthermore, since the data structure must be analyzed, the amount of calculation increases compared with the process of only its contents. Therefore, in a system utilizing XML, compared with that of the existing system, processing speed decreases and the amount of memory consumption increases. In that case, the resource consumption of a computer becomes a problem. As a result, particularly when processing a large capacity of data outputted from a legacy system, such as a relational database (RDB) or the like, for example, processing a large amount of data daily outputted (sales data daily inputted from a store, etc.), it is important how much to suppress resource consumption.

However, when attempting to process XML data using a conventional XML parser (base software for analyzing XML), the capacity of memory fails, processing speed decreases or the work of a programmer increases. Two kinds of conventional XML parsers are shown.

Prior Art 1: The case where a simple API for XML (SAX) is used.

FIG. 2 explains the SAX.

In a simple data processing of referring to data only once and processing it, a SAX parser is used. The SAX parser analyzes and processes data in a stream in units of elements. This technology has the following advantages and disadvantages.

Advantage:

Since data is transferred to a subsequent process without generating and storing objects when reading data, the used amount of memory is small.

Disadvantage:

Since objects are not generated, it is optimal when simply referring to it. However, when processing the existing data and further performing a subsequent process, objects must be generated later.

Furthermore, since data can be referenced only once, a merge in which data is accessed at random and a plurality of pieces of data is associated (a combining process of the tables of an RDB) is impossible.

Prior Art 2: The case where a document object model (DOM) is used.

FIGS. 3-5 explain the DOM.

A DOM parser stores full data on memory as tree-structured objects once. Its procedures at the time of retrieval or editing are as follows.

(1) Full data is developed on memory in a tree-structure once.

(2) Data is retrieved and edited following the tree structure on the memory.

Advantage:

Since data is stored on memory, the data can be accessed at random unlike SAX in which data can be referenced only once. Therefore, the retrieval or editing operation is easy.

Disadvantage:

All the tags in XML data and their contents are stored as tree-structured objects. However, in order to form a tree-structured object, an object must be generated for each tag, and the object of this tag must have very much information (member variables), such as a pointer to the object of a parent tag (sales result), a pointer to the object of a child (subtotal, unit price, quantity, commodity number) or the like, as shown in FIG. 4.

Therefore, a lot of memory and processing time are needed at one time. Typically, if memory approximately four times the file size is used and an amount of memory consumption is too much, paging and swapping occur, and as a result, there is a possibility that system performance may extremely degrade.

Therefore, for example, when performing a combining process as shown in FIG. 5, a very large capacity of memory is needed at one time.

In FIG. 5, a sales result which has a commodity number and quantity as its data and registers the number of sales and the data of commodity master for registering the data of a commodity, composed of a commodity number, a commodity description and a unit price are collated using the commodity number, and a sales subtotal is outputted. Firstly, DOM stores the data of the sales result and the data of the commodity master as tree-structured objects, extracts the commodity number from each object data and merges the data with the same commodity number. Thus, the object of the sales result can have a new unit price as data to be registered in each number of sales. Then, the subtotal of the data of each number of sales is calculated and is added as data.

As a conventional device for handling structured documents, Patent references 1 and 2 are known. Patent reference 1 improves the speed of the retrievals of the document structure and of attribute of a structured document by breaking down a structured document into partial structures and storing them in a relational database. Patent reference 2 improves processing speed by storing a structured document in a tree structure, breaking it down into branches and managing them, and processing them by developing the branches.

Patent Reference 1: Japanese Patent Application Publication No. 2003-67402

Patent Reference 2: Japanese Patent Application Publication No. 2003-178049

Although SAX has a small amount of memory consumption and a short processing time, it can neither access data at random nor in reality perform a complex process, such as the process of collating a plurality of pieces of data. Although DOM can access data at random, its amount of memory consumption and its processing time increases and it is difficult to transfer data to a subsequent process, since it stores full data as tree-structured objects.

### SUMMARY OF THE INVENTION

It is an object of the invention to provide a structured document processing system whose amount of memory consumption is small and which can apply a complex process to data.

The structured document processing system comprises a data extraction/storage unit for specifying/extracting a part describing a necessary data group from a structured document and storing the data group as text data, a specification information extraction unit for extracting specification information from the extracted text data by text retrieval and a processing unit for applying a desired process to the data group using the extracted specification information.

According to the present invention, since data can be partially referenced, retrieved and edited without generating tree structures, calculation costs and the amount of memory consumption can be greatly reduced.

### BRIEF DESCRIPTION OF THE DRAWINGS

FIG. 1 shows the data structure of a structured document.

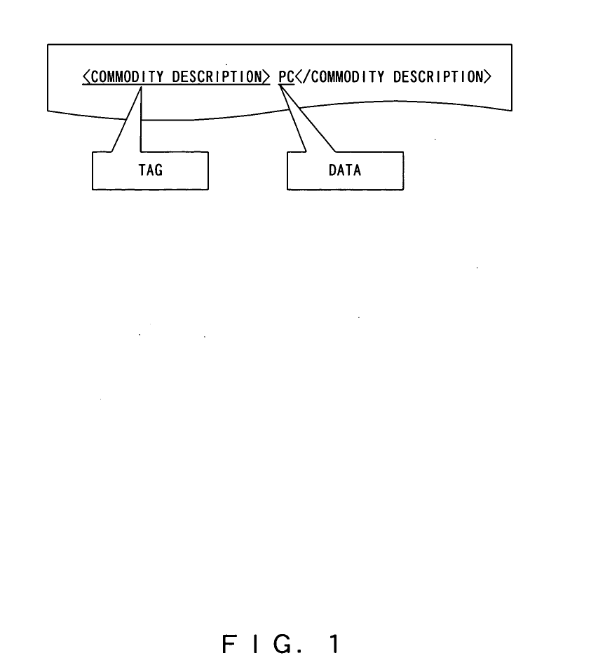

FIG. 2 explains SAX.

FIG. 3 explains DOM (No. 1).

FIG. 4 explains DOM (No. 2).

FIG. 5 explains DOM (No. 3).

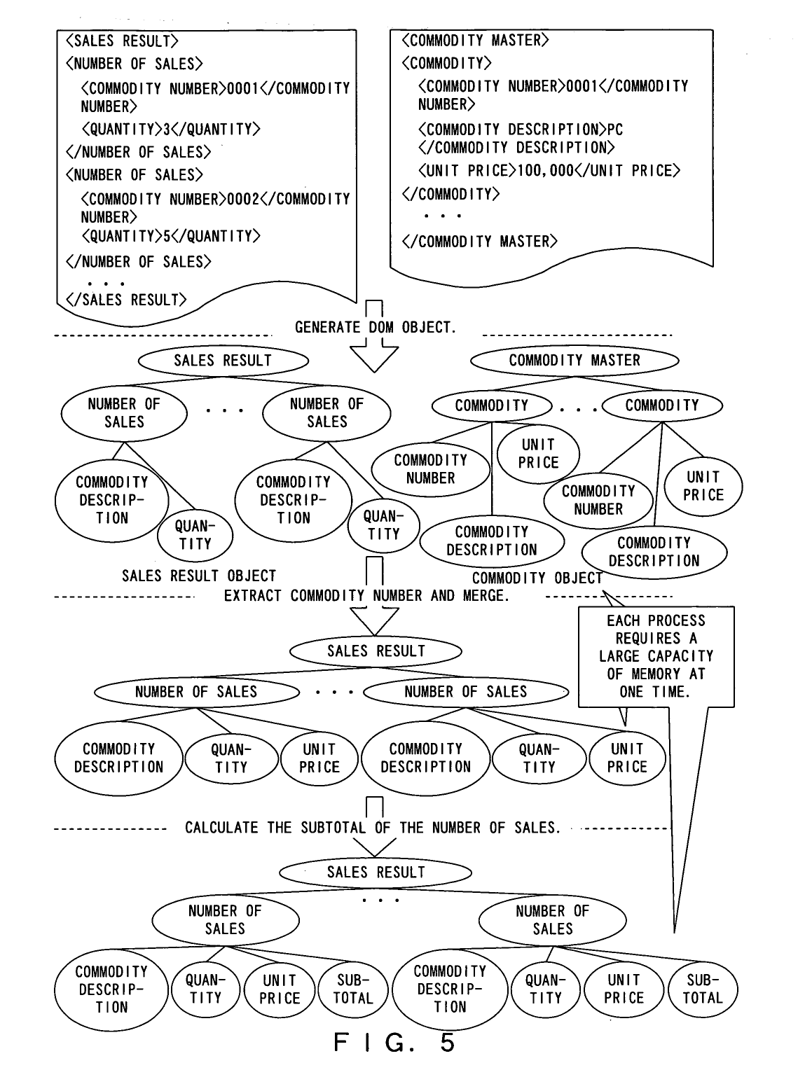

FIG. 6 shows how the preferred embodiment of the present invention handles data.

FIG. 7 shows an example of the process in units of records.

FIG. 8 shows how to combine the records in FIG. 2 (No. 1).

FIG. 9 shows how to combine the records in FIG. 2 (No. 2).

FIG. 10 shows how to combine the records in FIG. 2 (No. 3).

FIG. 11 shows how to combine the records in FIG. 2 (No. 4).

FIG. 12 shows how to combine the records in FIG. 2 (No. 5).

FIG. 13 shows the pipeline process in units of records.

FIG. 14 shows an XML declarative part.

FIG. 15 shows the concept of the process of combining sales information with commodity information to generate sales information with a unit price and a subtotal.

FIG. 16 shows the first configuration of the structured document processing system of the present invention (No. 1).

FIG. 17 shows the first configuration of the structured document processing system of the present invention (No. 2).

FIG. 18 shows the first configuration of the structured document processing system of the present invention (No. 3).

FIG. 19 shows the process of the first configuration of the structured document processing system of the present invention (No. 1).

FIG. 20 shows the process of the first configuration of the structured document processing system of the present invention (No. 2).

FIG. 21 shows the process of the first configuration of the structured document processing system of the present invention (No. 3).

FIG. 22 shows the process of the first configuration of the structured document processing system of the present invention (No. 4).

FIG. 23 shows the process of the first configuration of the structured document processing system of the present invention (No. 5).

FIG. 24 shows the process of the first configuration of the structured document processing system of the present invention (No. 6).

FIG. 25 shows the process of the first configuration of the structured document processing system of the present invention (No. 7).

FIG. 26 shows the second configuration of the structured document processing system in the preferred embodiment of the present invention.

FIG. 27 shows the process of the second configuration of the structured document processing system in the preferred embodiment of the present invention.

### DESCRIPTION OF THE PREFERRED EMBODIMENTS

The preferred embodiment of the present invention processes and analyzes the tag data of a structured document and transfers a part of it to a user application. The user application performs a data process, based on the transferred document and provides a variety of services.

More particularly, it extracts an XML document as a character string for each record (minimum process unit) and handles the record data extracted as character strings on the basis of text in order to solve the problem.

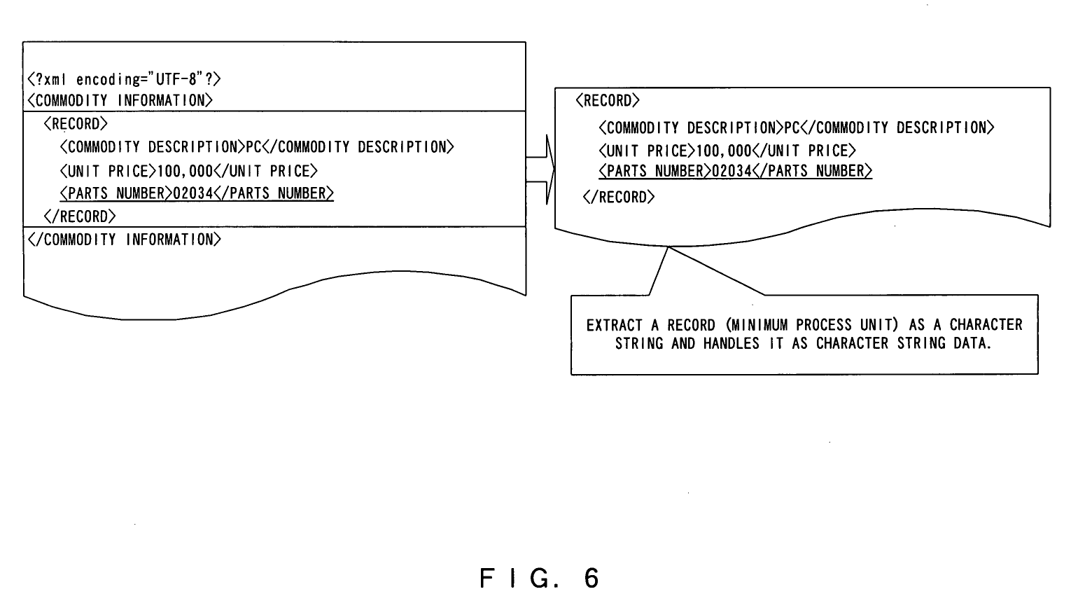

FIG. 6 shows how the preferred embodiment of the present invention handles data.

As described earlier, an XML document is provided with tags, and data enclosed by the tags can be individually processed. As shown in FIG. 6, although commodity information includes a commodity description, a unit price and a parts number, these constitute one record of commodity information. The preferred embodiment of the present invention extracts this record as a character string and stores it as character string data. Since the record data stored thus is stored as character string data on the basis of text, its data capacity is small. Whether an object is developed based on this character string data is arbitrary.

Data outputted from an RDB or the like is composed of a plurality of records. A record is the minimum data unit needed in each process. Therefore processes can be sequentially transferred and performed in units of records.

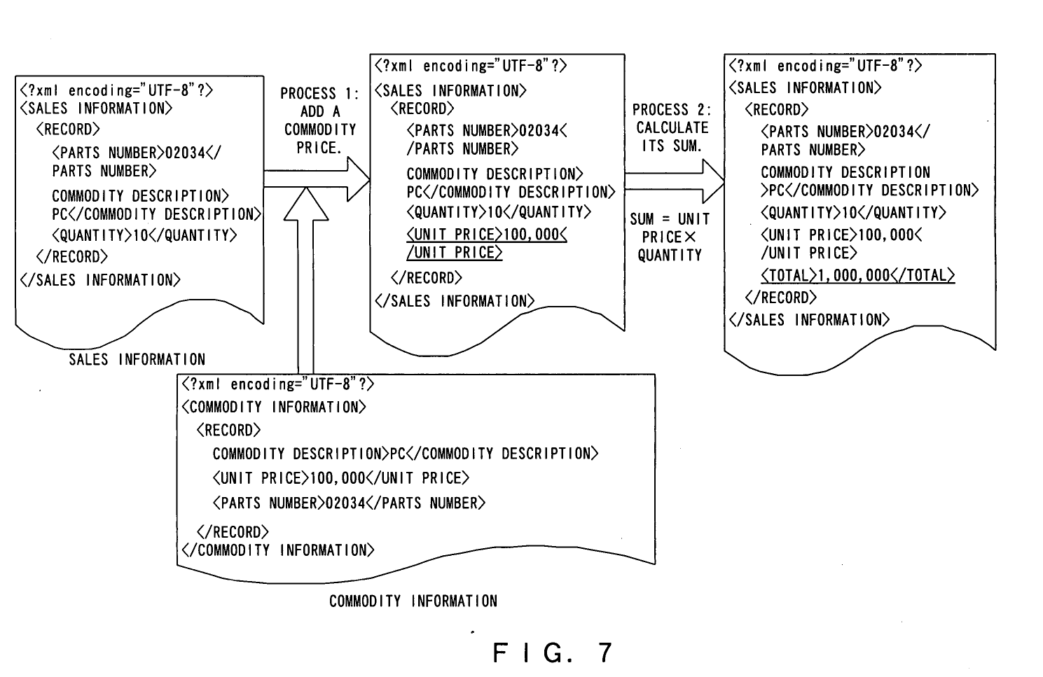

FIG. 7 shows an example of the process in units of records.

In FIG. 7, sales information and commodity information are processed and a unit price and the total amount of sales are added to the sales information.

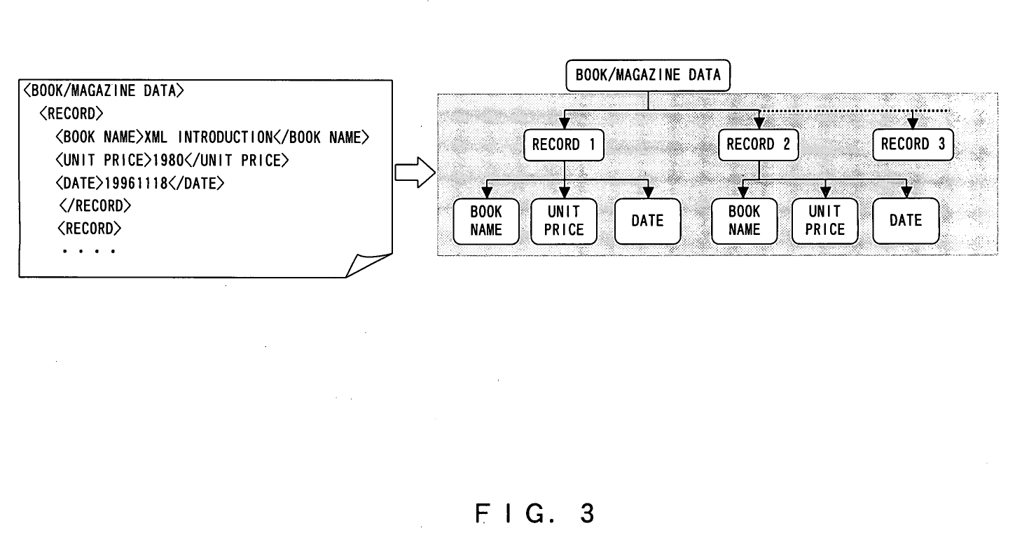

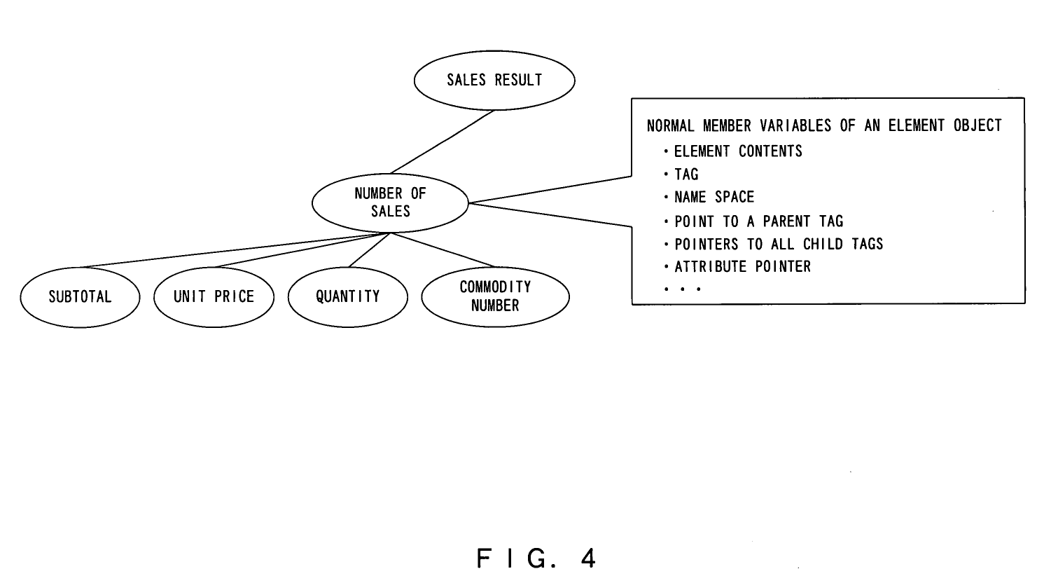

In this case, if the specification information of each record can be extracted, a plurality of pieces of data can be combined. In FIG. 7, the parts number corresponds to this. If a record is handled as a character string, it becomes a group of data. Therefore, there is no need to have a lot of member variables as in DOM described in FIGS. 3 and 4. Therefore, the amount of memory necessary for the process can be greatly reduced.

When performing process 1 shown in FIG. 7 handling each record as a character string, for example, the following process is executed by using a structured document processing system (Japanese Patent Application Publication No. 2003-178049 or Japanese Patent Application No. 2004-42289). This system obtains the leading position of a start tag of each record and the byte position of its end tag, and the byte positions of the start and end tags of each element of the record. Thus, a combining process can be executed in the following procedure.

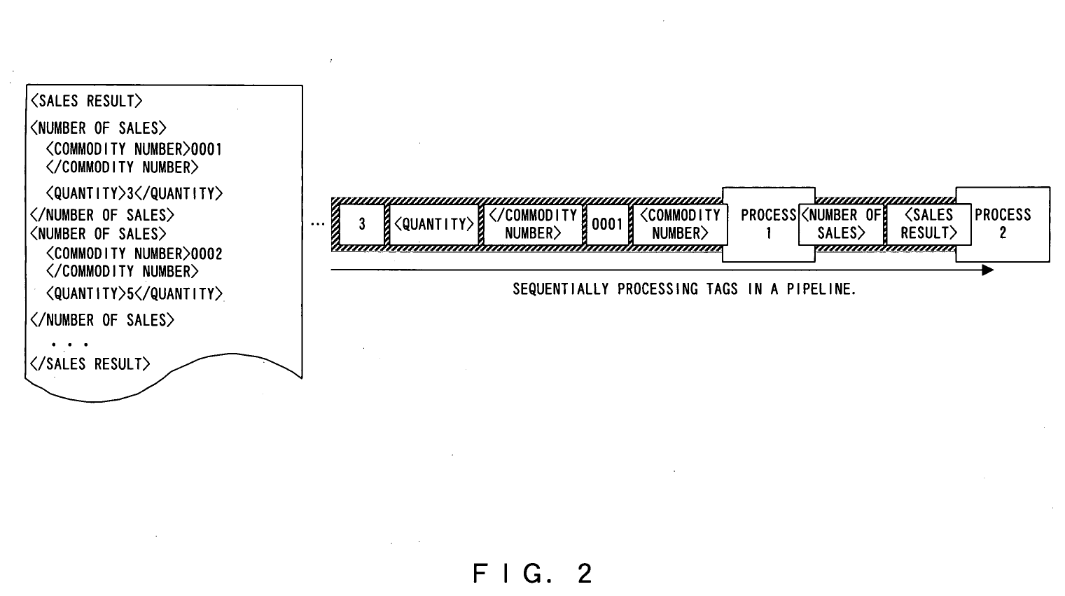

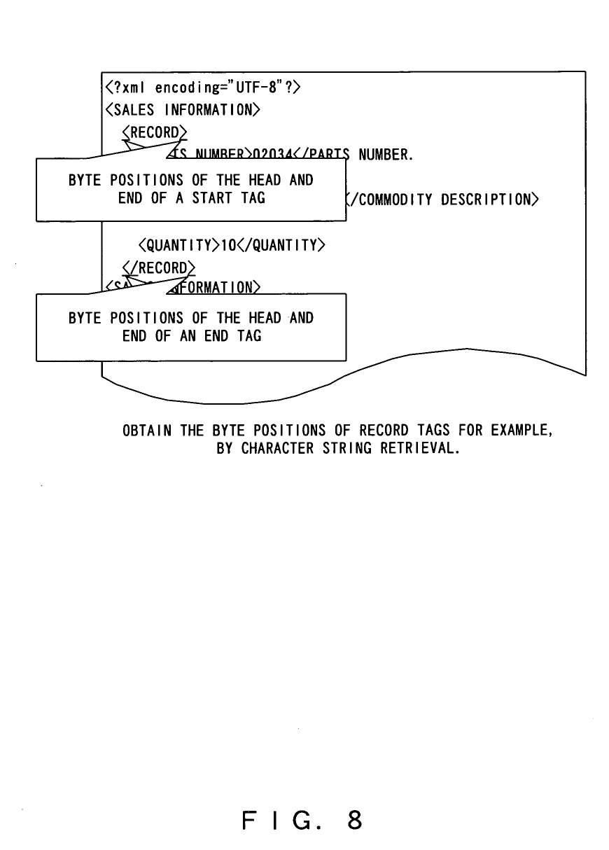

FIGS. 8-12 show the combining process in FIG. 2.

(1) The leading byte positions of the start and end tags of the record tag of sales information are obtained (FIG. 8).

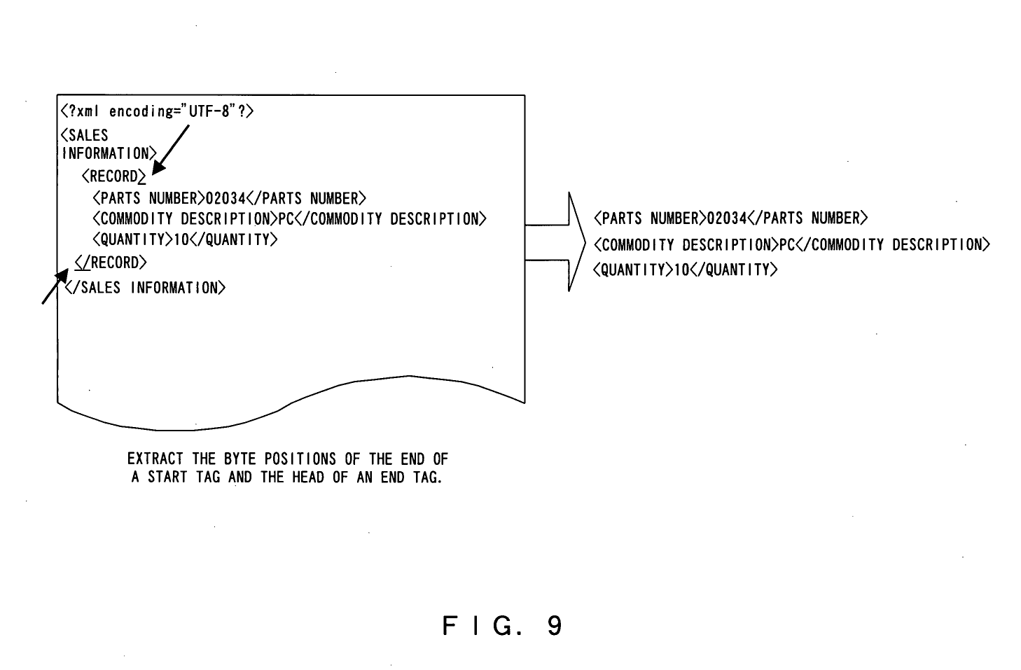

(2) All the element groups of the record are extracted from the byte positions (FIG. 9).

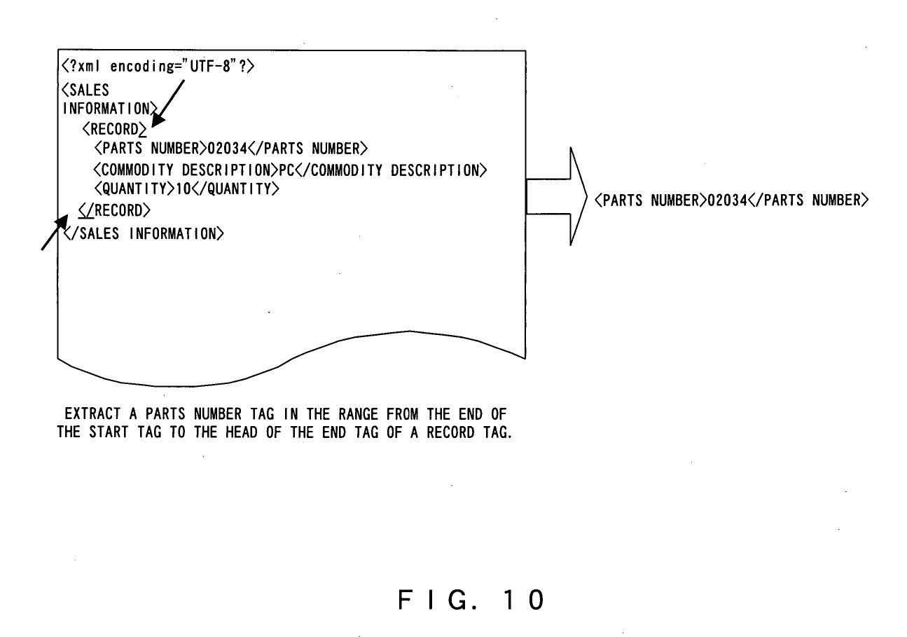

(3) A parts number tag existing in the byte positions obtained in (1) is obtained, and is specified as ID (FIG. 10).

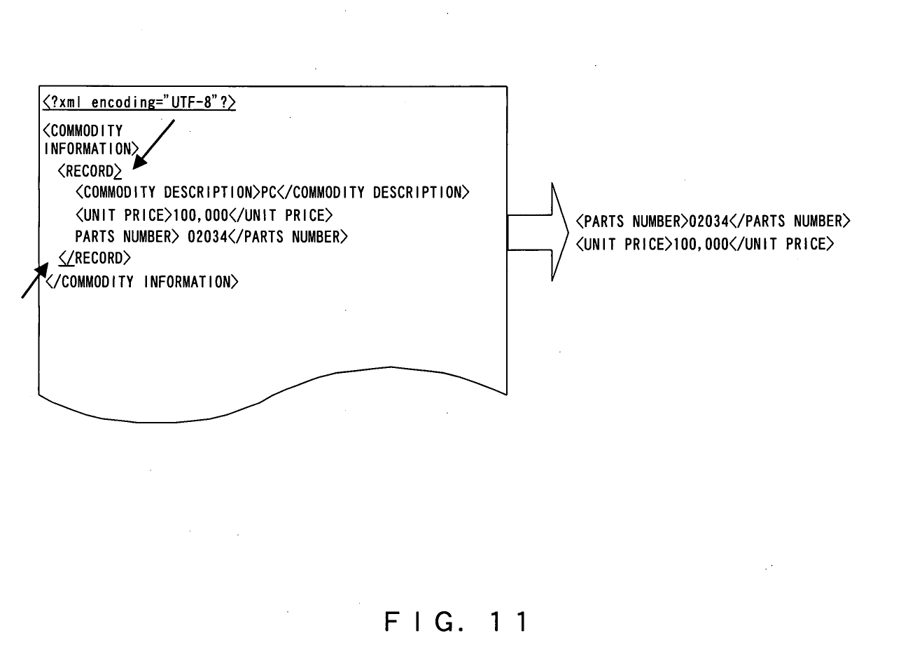

(4) By applying the same process to commodity information, the ID (parts number) and the leading byte positions of the start and end tags of the record tag are obtained (FIG. 11).

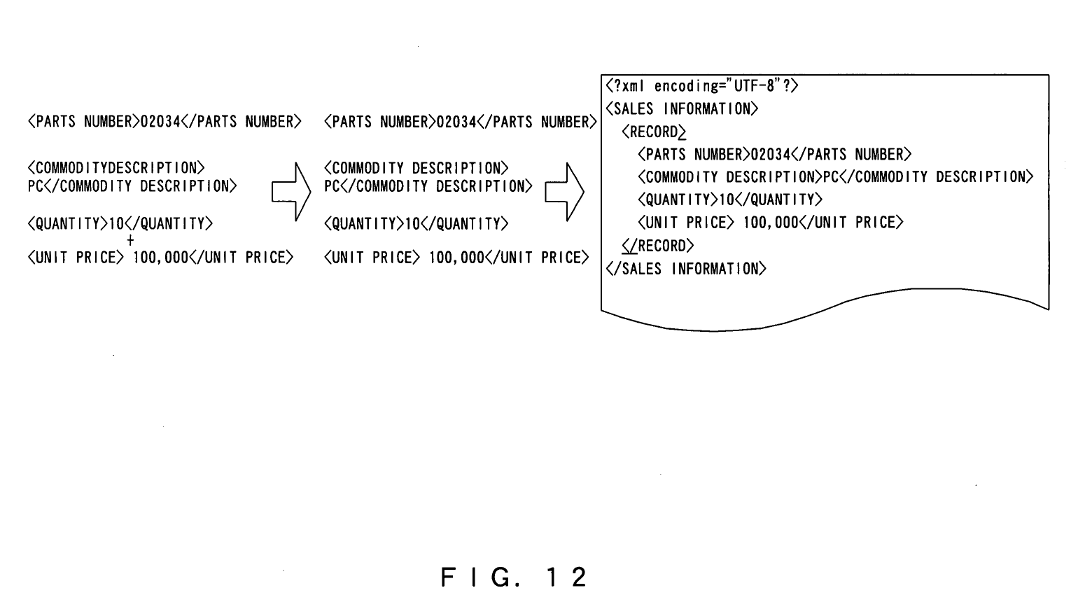

(5) The price tag of a record with the same ID is merged into the last end of the element group extracted in (2), and this element group is returned to the original record (FIG. 12).

In this case, data indicated by each tag is handled as a group of character string data. Therefore, processing speed and the amount of memory consumption can be reduced. Particularly, in the combining process or the like, it is enough if only the element contents of the ID are known. Therefore, there is no need to store all the tags in a tree structure.

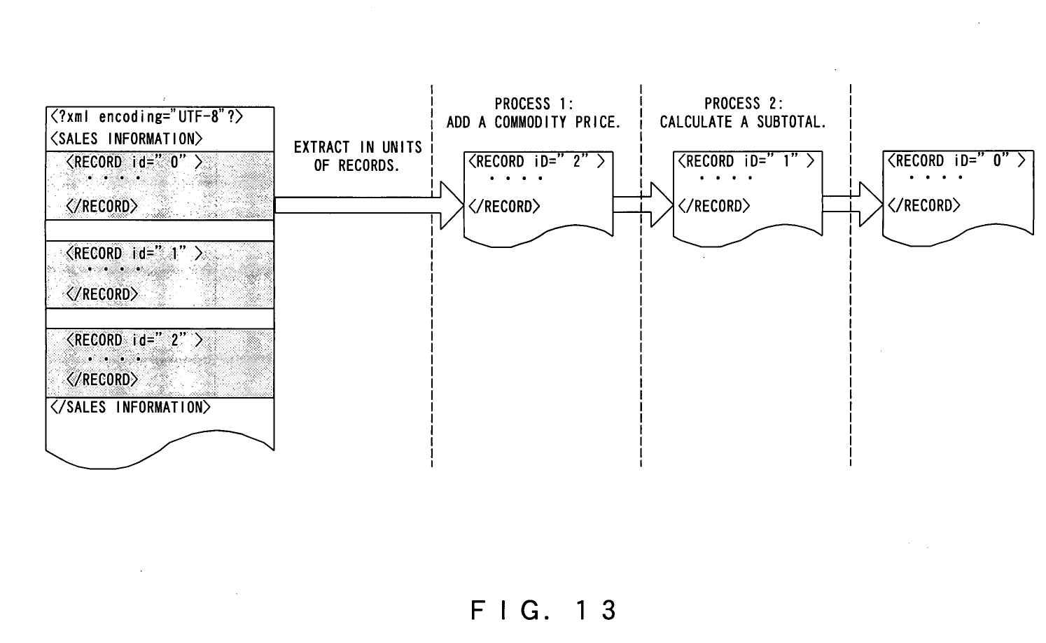

FIG. 13 shows the pipeline process in units of records.

If a lot of records must be processed at one time, as in the pipeline process of FIG. 13, after a specific process is applied to each record, the records are sequentially transferred to a subsequent process. In FIG. 13, processes 1 and 2 are independent, and a record whose ID is 2 is processed in process 1 while a record whose ID is 1 is being processed in process 2.

In the partially structured document analysis of an XML document, an XML declarative part or the like must be referenced for each data, and it must be analyzed by what character encoding the XML document is described.

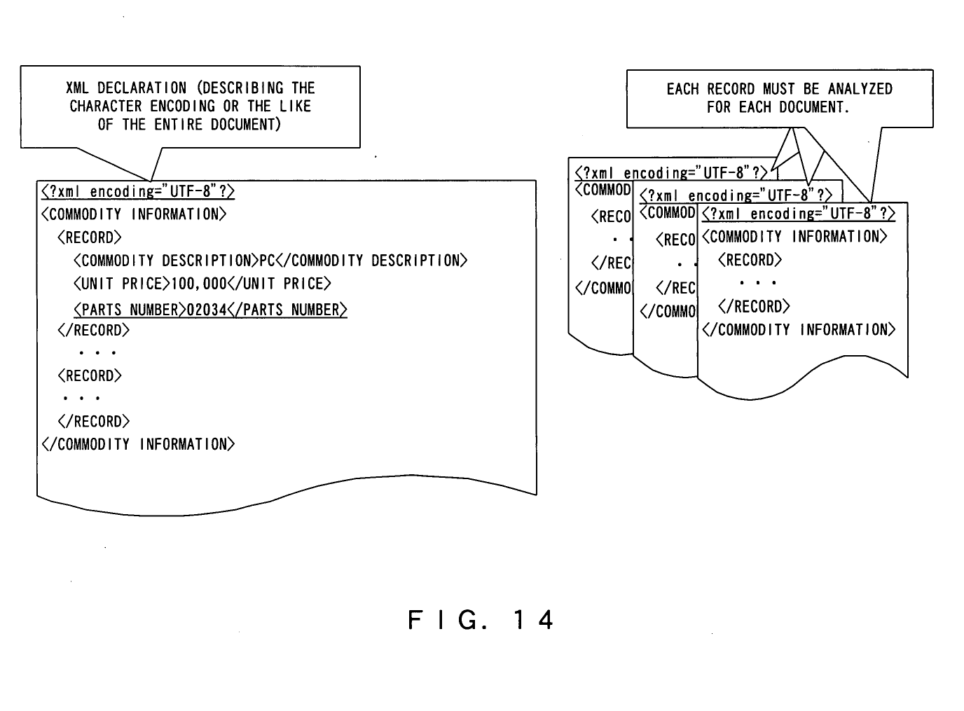

FIG. 14 shows an XML declarative part.

In an XML document containing a plurality of records, if there is only one XML declarative sentence at the head, this declarative sentence is effective for all records. However, if each record is handled as a different XML document, an XML declarative sentence is needed at the beginning of each document. In this case, when processing a document, this declarative sentence must be analyzed every time.

This analysis takes time. However, if this process is applied to an XML document in which all records are grouped into one piece of data, a one-time analysis of an XML declarative part is sufficient. Therefore, in this case, processing time is very short compared with the case where each document contains one record and the analysis of an XML declarative part is applied to each XML document.

By adopting the preferred embodiment of the present invention, the amount of calculation of structured document parse can be reduced and a pipeline process can be made possible. In data processing, sometimes there is no need to refer to the entire data. In such a case, there is no need to parse data like an object and to store full data in a tree structure. When storing objects in a tree structure, usually a computer must manage a document for each object. Therefore, particularly, it requires a large memory capacity and a large amount of calculation to manage a document composed of a plurality of objects, such as DOM. Accordingly, if a record can be extracted as a simple character string, the memory capacity and the amount of calculation can be reduced since it can be handled as a group of data.

According to the preferred embodiment of the present invention, the amount of structured document parse can be distributed. As described earlier, although it requires a large memory capacity and a large amount of calculation to generate an object, calculation load to an application can be reduced if a parsed object is transferred to the application. Besides the partially structured document analysis, the extraction of a partial object is also effective. Thus, the amount of calculation can be reduced and distributed.

The collation speed of specification information can also be improved. In FIG. 7, two pieces of data are merged using a parts number as a trigger. Such data uniquely specifies each record. Since this specification information is extracted at pinpoint in advance and is transferred to each pipeline process as shown in FIG. 13, usually each process can promptly refer to this part. Accordingly, a document can be processed at high speed.

In addition, the collation speed of specification information can be improved. If an index is embedded in XML data, the collation processing speed at the transmitting destination of a record can be improved. Thus, the processing speed of specification information can be improved.

The process of calculating a sales result by combining two pieces of data is described below as an example.

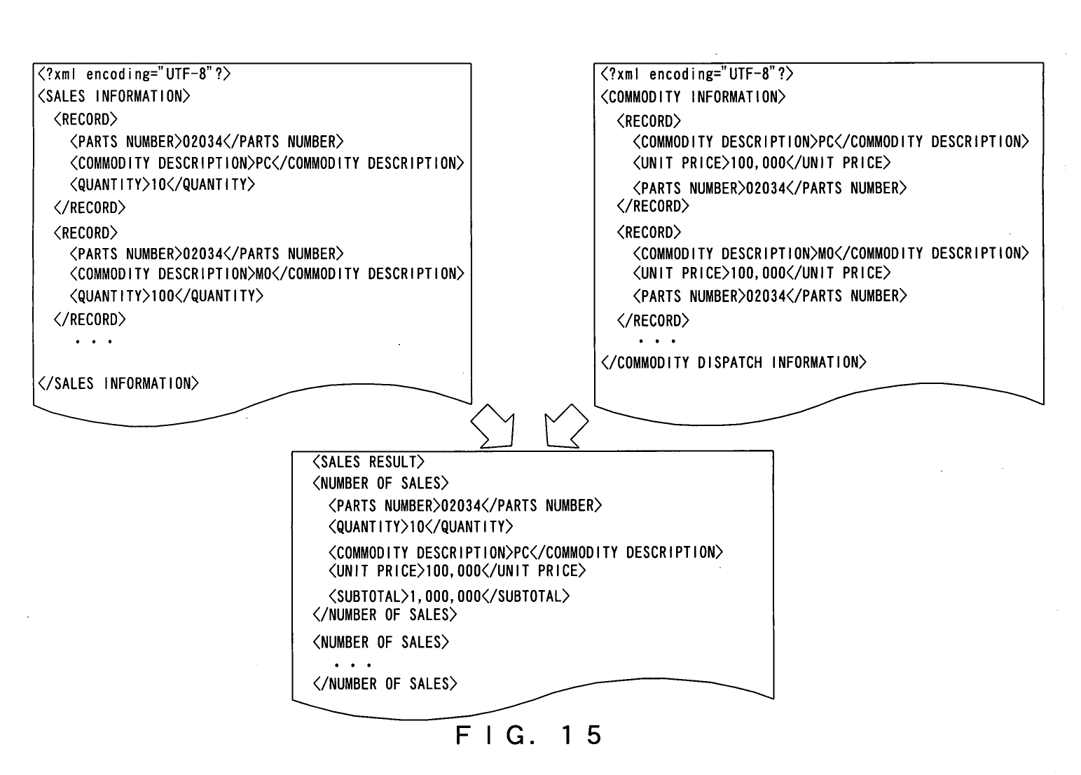

FIG. 15 shows the concept of the process of combining sales information with commodity information to generate sales information with a unit price and a subtotal.

Sales information stores a plurality of records, being a data process unit, and each record is composed of a parts number, a commodity description and quantity. Commodity information stores a plurality of records with a commodity description, a unit price and a parts number. In the following process, the respective parts numbers of the sales information and commodity information are collated, and a price as a unit price and a subtotal obtained as a calculation result are stored in a corresponding sales information record.

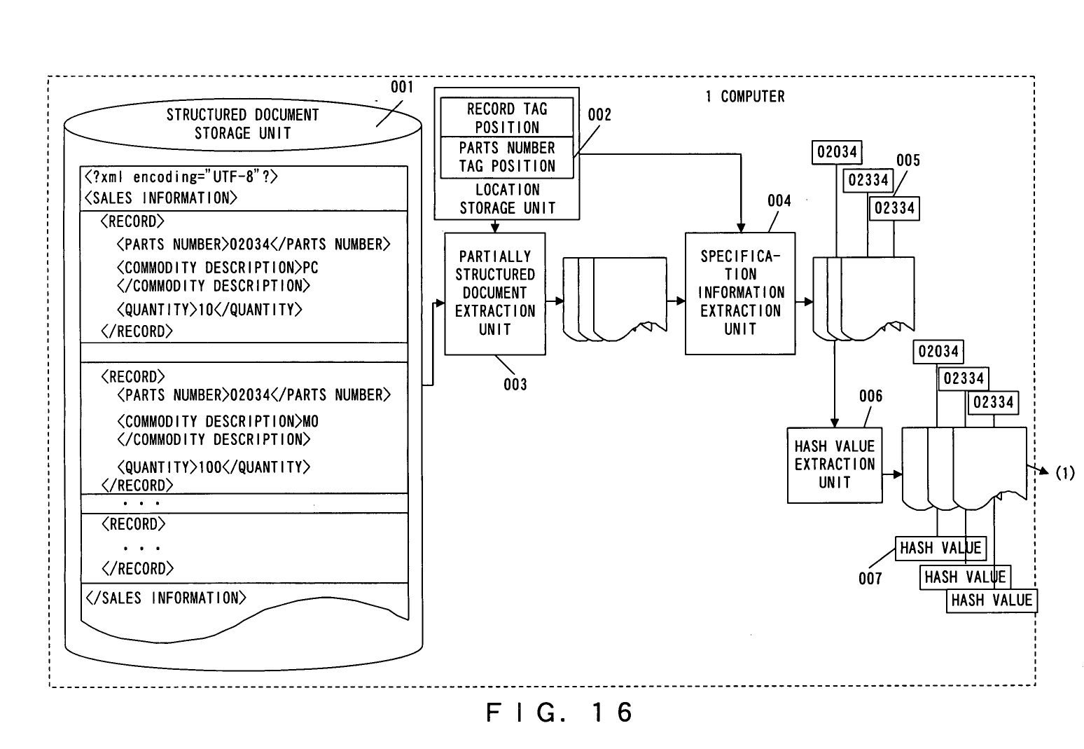

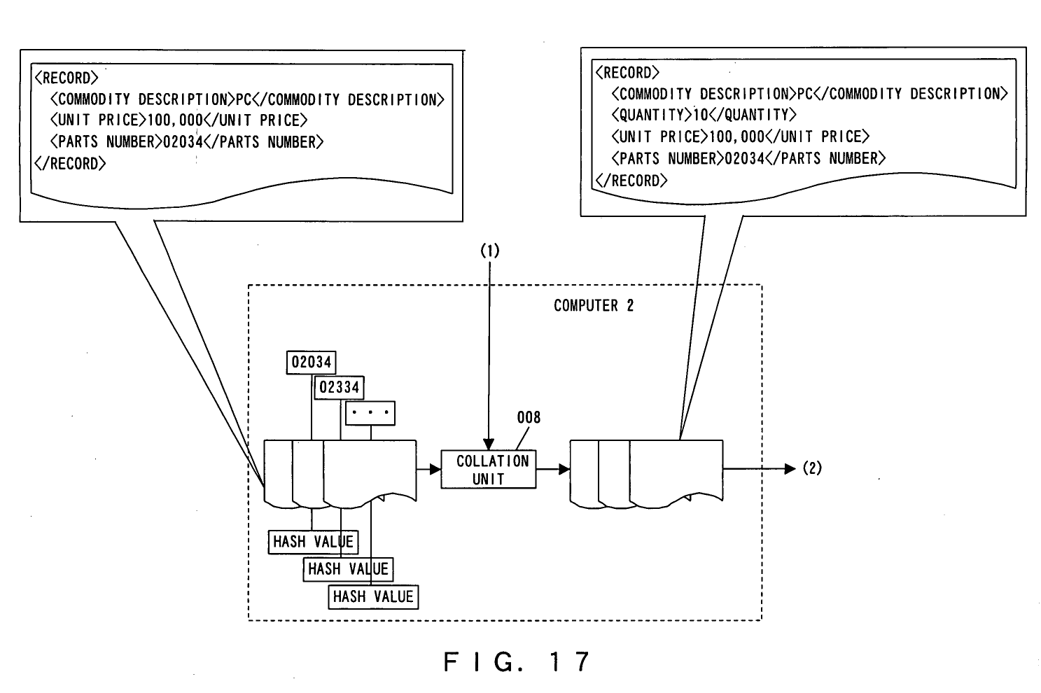

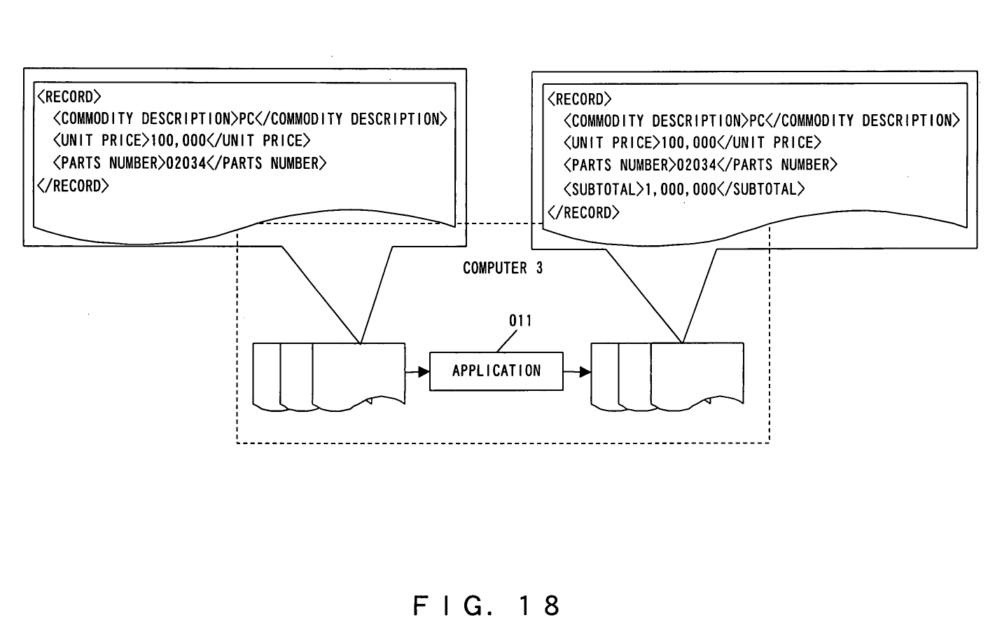

FIGS. 16-18 show the first configuration of the structured document processing system of the present invention.

In FIG. 16, a computer 1 comprises a structured document storage unit 001, a location storage unit 002, a partially structured document extraction unit 003, a specification information extraction unit 004 and a hash value calculation unit 006. The structured document storage unit 001 stores a structured document. The location storage unit 002 analyzes a structured document in advance and stores only location information (byte position from the head) of a record tag and a parts number tag.

The partially structured document extraction unit 003 extracts a partially structured document and a structured document from records, based on the byte position of a record tag, stored in the location storage unit 002. The specification information extraction unit 004 parts extracts number information, based on the byte position of a parts number tag stored in the location storage unit 002. Specification information 005 is used to specify each record. The hash value calculation unit 006 calculates a hash value, based on the byte array of a parts number. A hash value 007 is an index for collation, and is used in a collation unit 008. A computer 2 comprises the collation unit 008. The collation unit 008 collates parts numbers. An application 011 is comprised by a computer 3, and calculates a subtotal by multiplying a unit price by quantity for each object.

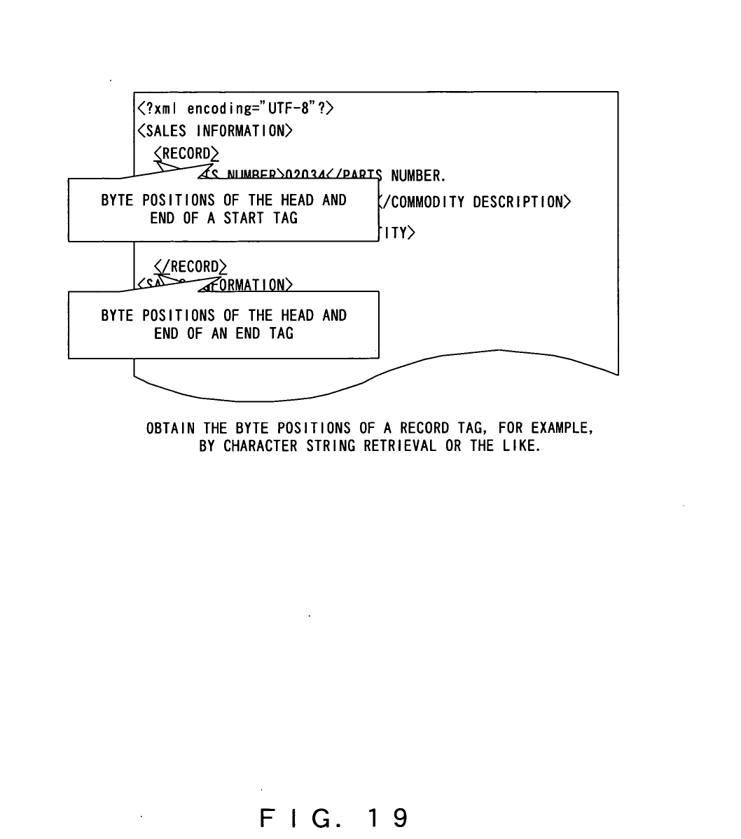

FIGS. 19-25 show the process of the first configuration of the structured document processing system of the present invention.

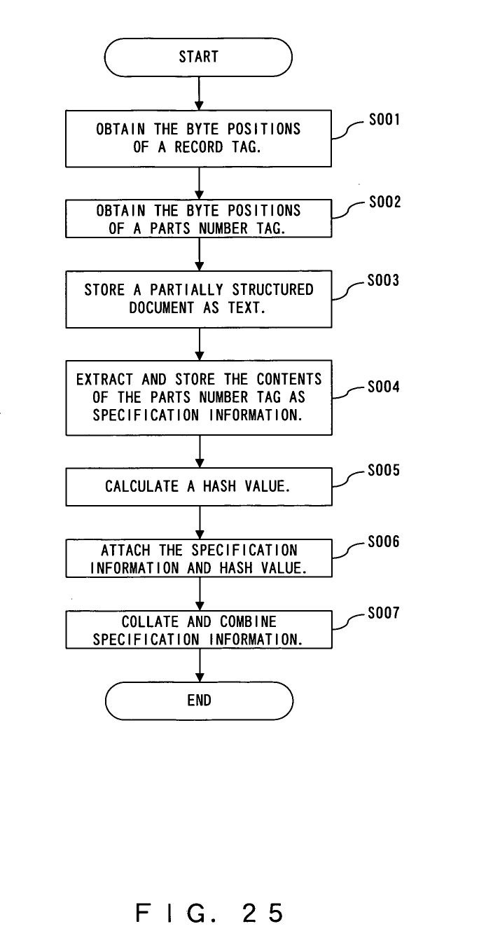

The process is described according to the flowchart shown in FIG. 25 with reference to FIGS. 19-24.

The entire structured document is analyzed and the byte position of a record tag is obtained. Firstly, the respective leading byte positions of the start and end tags of the record tag of sales information are obtained and are stored in the location storage unit 002. As shown in FIG. 19, the byte position of a record tag can be obtained by retrieving text from read XML document data.

S002:

By the same method, the byte position of a parts number tag between the start and end tags of the record tag, and is stored in the location storage unit 002.

S003:

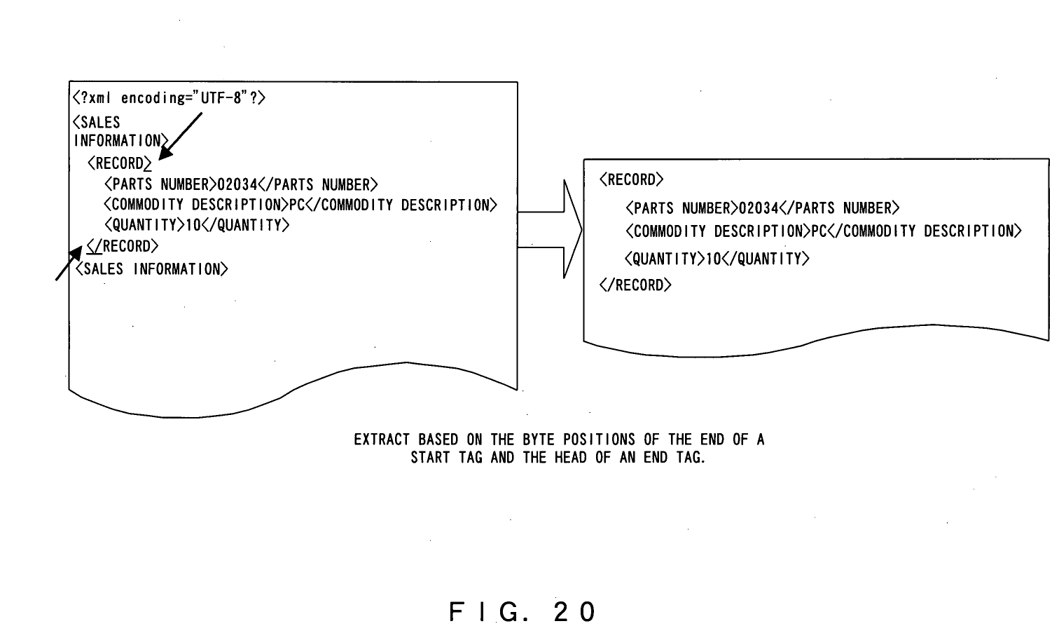

A partially structured document is extracted from the byte position of the record tag as text, and is stored as text. As shown in FIG. 20, data enclosed with the record tags is stored as text data.

S004:

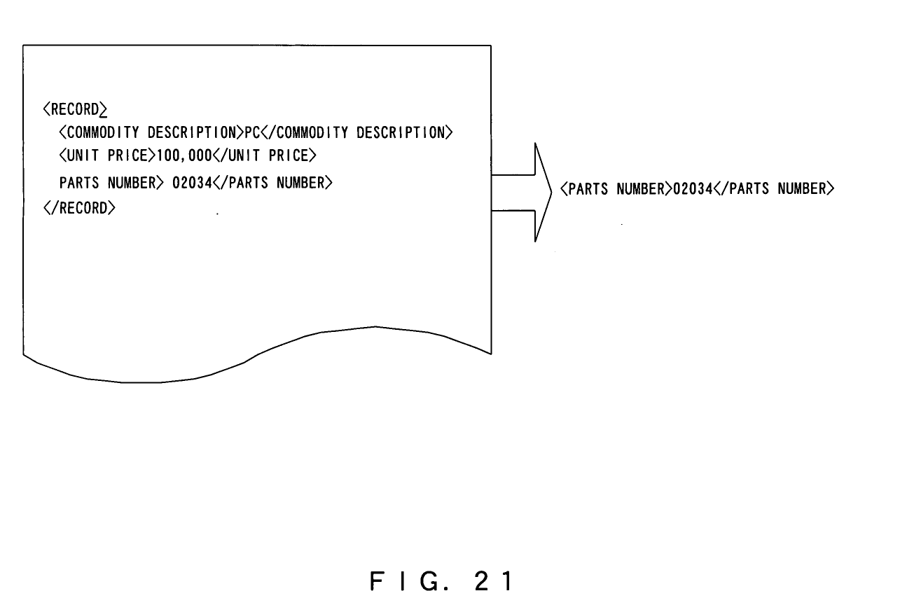

The contents of the parts number tag are extracted from the byte position of the parts number tag as specification information and are stored. As shown in FIG. 21, the parts number tag and its contents data “02034” are extracted and stored.

S005:

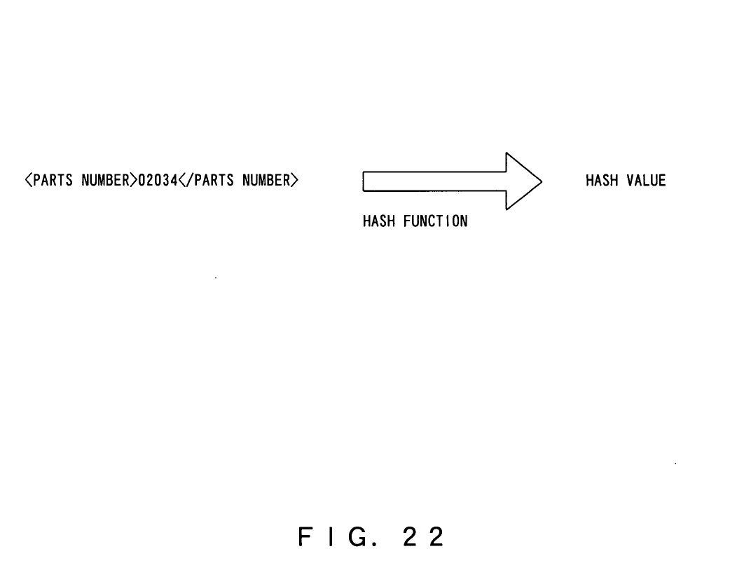

The hash value of the specification information is calculated. As shown in FIG. 22, a hash value is calculated based on the contents data of the parts number tag “02034”.

S006:

The specification information and hash value are attached to each partially structured document.

S007:

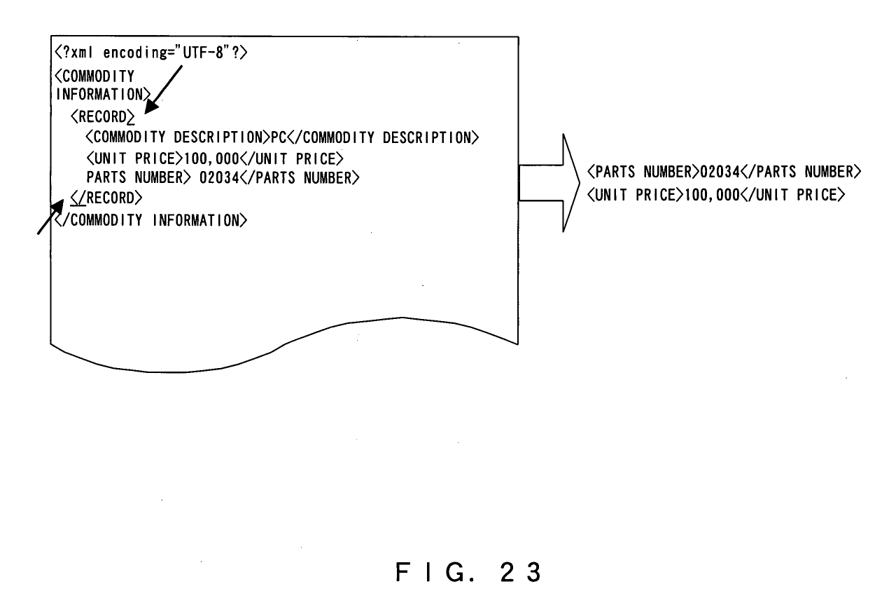

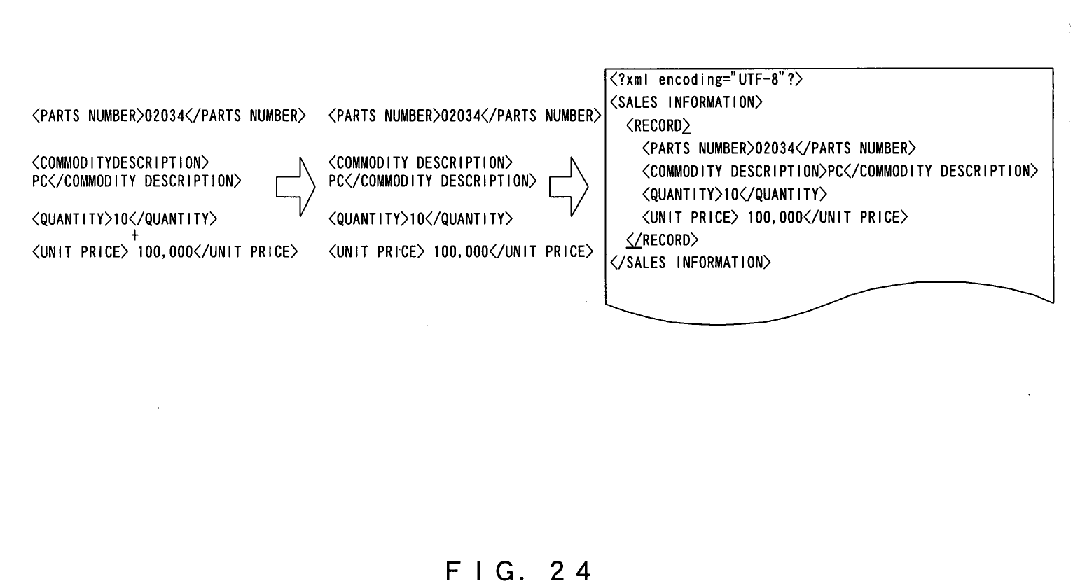

The specification information is collated and combined. Specifically, as shown in FIG. 23, by also applying the same process to commodity information, respective byte positions are obtained from the respective heads of the start and end tags of a parts number and a record, the parts number is extracted and a hash value corresponding to the parts number is calculated. Then, the hash value is attached to the partially structured document obtained from the commodity information, and the hash value obtained from the sales information and the hash value obtained from the commodity information are collated. A price is merged and written into the partially structured document of the matched sales information (FIG. 24).

According to the above-described configuration, since a record can be transferred to a subsequent computer as soon as each computer has processed each record, the load of each computer can be reduced, and also each computer can process a record independently of another computer. Since the present invention does not generate an object in a tree structure unlike DOM, the load of a computer can be reduced.

For the extraction unit 003 and location storage unit 002 used in this case, for example, the technology of Japanese Patent Application Publication No, 2003-178049 or Japanese Patent Application No. 2004-42289 can be used. If a tag position can be obtained, the same effect can be obtained.

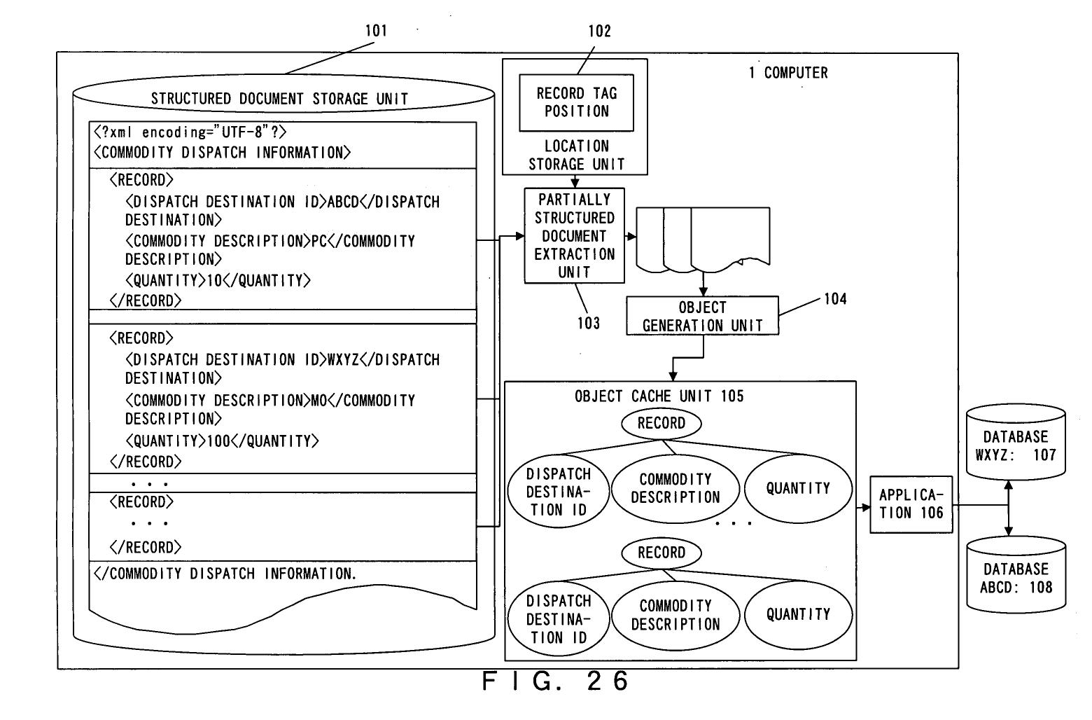

FIG. 26 shows the second configuration of the structured document processing system in the preferred embodiment of the present invention.

In this system, each record is distributed and stored in the database of its dispatch destination according to its dispatch destination ID.

A computer 1 comprises a structured document storage unit 101, a location storage unit 102, a partially structured document extraction unit 103, an object generation unit 104, an object cache unit 105 and an application 106. The structured document storage unit 101 stores a structured document to be processed. The partially structured document extraction unit 103 extracts a record as a partially structured document, based on the byte position of a pre-stored record tag. The location storage unit 102 analyzes a structured document in advance and stores only the location information of a record tag. The object generation unit 104 generates a partial object from the partially structured document. For the object generation unit 104, DOM or the like can be used. The object cache unit 105 caches the generated object. The application 106 processes the generated object. A database 107 stores each record. A database 108 also stores each record. The databases 107 and 108 sorts and stores the processed records, for which there is no need to be different.

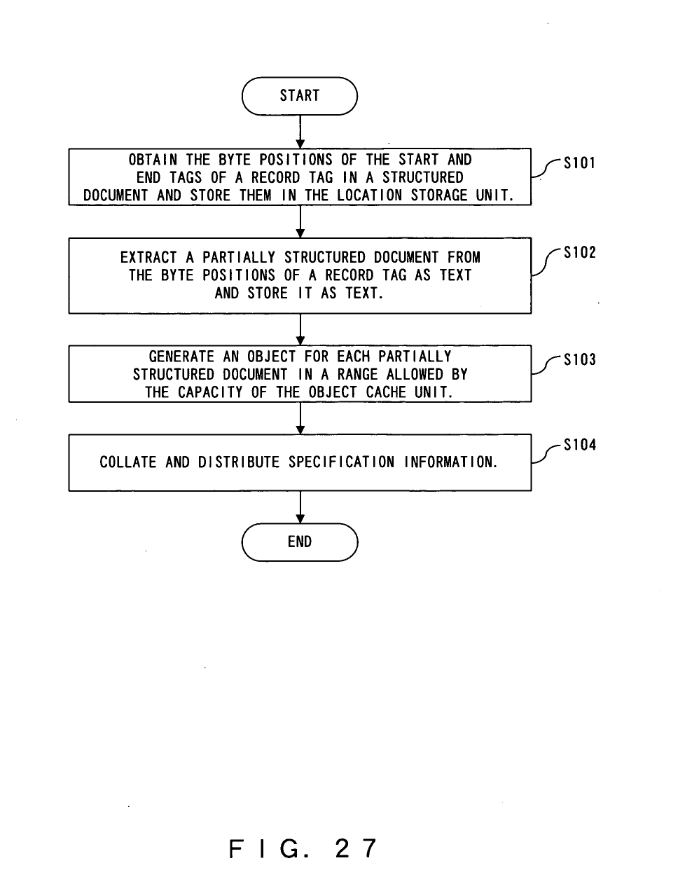

FIG. 27 shows the process of the second configuration of the structured document processing system in the preferred embodiment of the present invention.

The flow of the process is described below with reference to FIG. 27.

S101:

The entire structured document is analyzed and the byte position of a record tag is obtained. Firstly, the respective leading byte positions of the start and end tags of the record tag of sales information are obtained and are stored in the location storage unit 002.

S102:

A partially structured document is extracted from the byte position of the record tag as text, and is stored as text.

S103:

A partial object is generated for each partially structured document and is stored in the object cache unit 105. In this case, the number or capacity of the generated partial objects is restricted in such a way not to cause performance degradation factors, such as paging, swapping and the like, and the generated partial objects are stored in the object cache unit 105.

S104:

The element contents of the dispatch destination ID of each object are checked and the application 106 transfers each partial object to its database. After the application distributes the objects, the objects stored in the object cache unit 105 are erased.

What is claimed is:

1. A structured document processing system, comprising:
a data extraction/storage unit for specifying/extracting a part describing a necessary data group from a structured document and storing the data group as text data;
a specification information extraction unit for extracting specification information from the extracted text data by text retrieval; and
a processing unit for applying a desired process to the data group using the extracted specification information.

2. The structured document processing system according to claim 1, further comprising
an object development unit for developing the extracted data group as text data, as an object, based on the extracted specification information.

3. The structured document processing system according to claim 2, wherein
said object development unit restricts the number or capacity of developed objects in such a way that the structured document processing system may not incur performance degradation due to its load and develops the objects.

4. The structured document processing system according to claim 1, wherein
the specification information uniquely specifies the extracted text data.

5. The structured document processing system according to claim 4, wherein
an index for specifying the extracted text data is generated.

6. The structured document processing system according to claim 1, wherein
the desired process is applied to the data group stored as the text data by a pipeline process.

7. A structured document processing method, comprising:
specifying/extracting a part describing a necessary data group from a structured document and storing the data group as text data;
extracting specification information from the extracted text data by text retrieval; and
applying a desired process to the data group, using the extracted specification information.

8. A program for enabling a computer to implement a structured document processing method, the method comprising:
specifying/extracting a part describing a necessary data group from a structured document and storing the data group as text data;
extracting specification information from the extracted text data by text retrieval; and
applying a desired process to the data group, using the extracted specification information.
